(19) United States
(12) Patent Application Publication
(10) Pub. No.: US 2013/0090050 A1
(43) Pub. Date: Apr. 11, 2013

(54) HVAC System for a Parked Vehicle

(71) Applicant: James S. Bianco, Suffield, CT (US)

(72) Inventor: James S. Bianco, Suffield, CT (US)

(21) Appl. No.: 13/645,639

(22) Filed: Oct. 5, 2012

Related U.S. Application Data
(60) Provisional application No. 61/544,070, filed on Oct. 6, 2011.

(51) Int. Cl. B60H 1/00

(52) U.S. Cl. CPC B60H 1/0025
USPC 454/119

(57) ABSTRACT

An HVAC system mounted at an elevated position employs a pair of hoses which connect with a service module. The service module is adapted to be received in an access port of a vehicle to provide heating, ventilation and air conditioning while the vehicle is stationary. The service module carries magnets to magnetically bond with an adapter of the access port. A quick disconnect feature is provided to allow the vehicle to drive away while the HVAC system is operational and to decouple the service module from the access port without manually dismounting the service module from the access port.

### CROSS-REFERENCE TO RELATED APPLICATION

This application claims the priority of U.S. Provisional Patent Application No. 61/544,070 filed on Oct. 6, 2011, the disclosure of which is incorporated herein by reference in its entirety.

### BACKGROUND

This disclosure relates generally to providing air conditioning and heat to a parked vehicle with an idle engine. More particularly, this disclosure relates to a system and a method to heat and/or cool a vehicle, such as an ambulance, from an off board stationary heating, ventilation and air conditioning (HVAC) unit.

When an ambulance is parked waiting for either service or to respond to an emergency, it is necessary to keep the interior of the ambulance at a relatively normal temperature to prevent the spoilage of on board medications and to keep a comfortable environment for the EMT personnel.

It is possible to cool or heat the interior of the ambulance with the HVAC unit driven by the vehicle engine, but that would make it necessary to run the engine for large periods of time. Continuously running the engine while the vehicle is stationary not only consumes a great deal of fuel, but causes excessive wear and tear on the engine and has adverse environmental consequences.

It is possible to add a second HVAC unit to the ambulance that operates from grid power and can be plugged into an outlet when the ambulance is parked and the engine idle. However, in this case, a secondary HVAC unit needs to be installed in the entire fleet—a very costly solution.

### SUMMARY

Briefly stated, a cost effective solution is to provide an HVAC unit at the locations where the vehicles or ambulances would be parked and to power the HVAC unit from the grid. The HVAC unit supplies both heat and air conditioning through a short flexible hose which attaches either to the window of the cab or to a special quick disconnect port in the carrier part of the ambulance. In one embodiment, the driver of the ambulance can simply drive away from the HVAC station, and the hoses would automatically separate from the ambulance. The separation also automatically turns off the HVAC unit.

One or more HVAC units are preferably mounted to a post which may be movable but is preferably stationary. A hose is suspended to supply heated or cooled air to a vehicle either by a decouplable module or a special quick disconnect service module which preferably interacts with an adapter mounted at an access port of the vehicle. Although not necessary, the HVAC unit and service module may also have a return air hose from the vehicle, which is also attached to the vehicle via the adapter.

The service module is equipped with a temperature sensor which measures the ambient temperature in the vehicle, and via its associated electronic circuits, controls the HVAC unit. The service module is also optionally equipped with a sensor that detects the presence of the service module at the access opening, signaling the HVAC unit to turn on when installed and off when removed.

An ultraviolet light is optimally located in the interior of the HVAC unit to purify the cooling function and reduce the spread of airborne diseases. The modular design also aids in a quick installation and servicing of the HVAC units.

Briefly stated, an HVAC system for a vehicle comprises a post disposed in upright relationship. An HVAC module is mounted to the post at an elevated position and has a bottom panel. At least one flexible hose is suspended from the bottom panel of the HVAC module. A service module receives an end portion of each flexible hose. A magnet is carried by the service module. The service module preferably has a circumferential rim.

The service module has a tilt sensor and a forward service panel with a temperature sensor mounted at the service panel. Each flexible hose is further decouplable from the service module should the vehicle drive away from the HVAC system.

A second HVAC module is mounted to the post opposite the first HVAC module. The second HVAC module comprises a second set of at least one flexible hose suspended from a bottom panel of the second HVAC module and a second service module receiving an end of each flexible hose of the second set.

A vehicle having a service door opens to access an access port having an adapter. The adapter defines an inlet and an outlet to and from the interior of the vehicle. One HVAC system embodiment preferably comprises an upright post. An HVAC module is mounted to the post at an elevated position. The HVAC module has a panel. A pair of flexible hoses extends from the panel. A service module is mounted to end portions of the hoses. The service module is positioned at the access port with the hoses fluidly communicating with the inlet and the outlet, and the service module is magnetically attracted toward the adapter.

The service module carries a pair of magnets and the adapter comprises a metal plate. The service module has a temperature sensor. The service door is pivotally mounted to the vehicle in an upward location and opens outwardly from the vehicle. The service module also supplies shore power to the vehicle.

An HVAC station comprises an HVAC module. A pair of flexible hoses communicates with the HVAC module. A service panel assembly receives ends of the hoses and carries at least one magnet. A tether assembly connects the HVAC module and the service panel assembly. The panel assembly may be installed in an access port of a stationary vehicle in a vertical orientation and, upon driving said vehicle away from the HVAC station, the panel assembly is dismounted from the access port and is tethered to the HVAC module by the tether assembly.

The tether assembly comprises a telescopic assembly comprising a tube and a reciprocating rod. The tube has a first connecter and the rod has a second connector which connects with the service panel assembly. The HVAC module has a forwardly projecting bracket. The first connector connects the bracket in another universal connection. The second connector connects the panel assembly in a universal connection. A guide projects forwardly from the HVAC module and comprises a pair of spaced edges which define a stop for limiting lateral displacement of the telescopic assembly. The service panel assembly further comprises an electrical connector for a cord which extends from the HVAC module. The service panel assembly has a temperature sensor to sense the temperature at the interior of the vehicle.

An absorber spring assembly is interposed between the telescopic assembly and the HVAC module to provide a shock absorber to limit displacement of the telescopic tube assembly. The service panel assembly comprises a frontal panel and a recessed circumferential rim. The HVAC module comprises a bottom panel. A pair of flexible hoses extends from the bottom panel. The hoses are substantially identical with a substantially accordion fold-type construction. The vehicle is preferably an ambulance with an access port at a side location or a rear location of the carrier compartment. The service panel assembly and the access port have generally complementary shaped portions.

### BRIEF DESCRIPTION OF THE DRAWINGS

FIG. 1 is a perspective view, partly in phantom, of an HVAC station comprising an HVAC module mounted on a post;

FIG. 2 is an enlarged end perspective view, partly in phantom, of a service module and end portions of connecting hoses for the HVAC module of FIG. 1;

FIG. 3 is a perspective view of an adapter plate assembly for the service module of FIG. 2 further showing a portion of a mounted power cord;

FIG. 4A is a fragmentary cutaway view, partly in section and partly in diagram form, of a side of an ambulance through an HVAC access window showing the HVAC service module prior to installation and an access door in the opened position;

FIG. 4B is a fragmentary cutaway view, partly in section, of the side of the ambulance through the HVAC access window showing the installed service module and the access door resting on the HVAC supply hose;

FIG. 5 is an elevational view of the HVAC module of FIG. 1 and an ambulance with a service module attached to the access window of the ambulance;

FIG. 6A is a perspective view of a dual HVAC station comprising two HVAC modules mounted on a post;

FIG. 6B is an end and front elevational view of two ambulances parked adjacent the dual HVAC station of FIG. 6A with HVAC service modules installed in each vehicle and annotated to show access port locations;

FIG. 7 is an elevational view of an HVAC module mounted to a post, portions shown in phantom and portions removed, and modified to incorporate a quick disconnect feature;

FIG. 8 is an enlarged view, portions in phantom, illustrating the upper circled portion of FIG. 7;

FIG. 9 is an enlarged view of the lower circled portion of FIG. 7;

FIG. 10 is a side elevational view of an HVAC module mounted to a post, further illustrating in diagrammatic form, the quick disconnect feature of FIG. 7, portions of the hose in the foreground being omitted for purposes of clarity;

FIG. 11 is a side elevational view of the HVAC system with the quick disconnect feature of FIG. 10, and further connected for operation to an ambulance partially illustrated;

FIG. 12 is an enlarged, fragmentary top plan view, partially in phantom and in diagrammatic form, illustrating the operation of a quick disconnect feature of the HVAC module, portions of the hoses being omitted for purposes of clarity; and

FIG. 13 is an enlarged end perspective view, partly in phantom, of an alternative embodiment of the service module and hose portions of FIG. 2.

### DETAILED DESCRIPTION

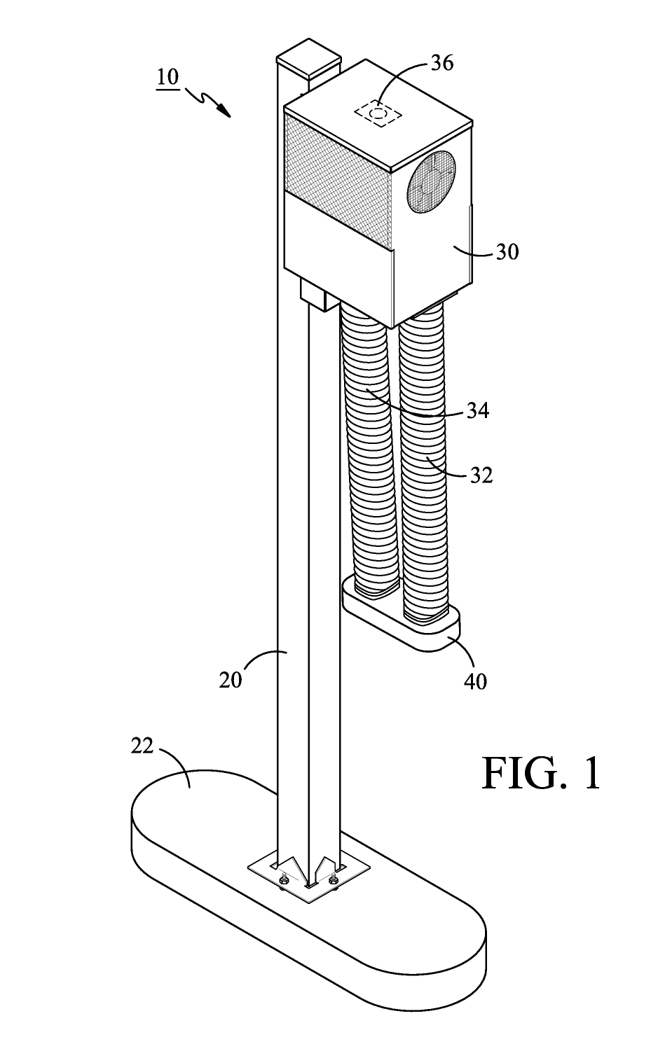

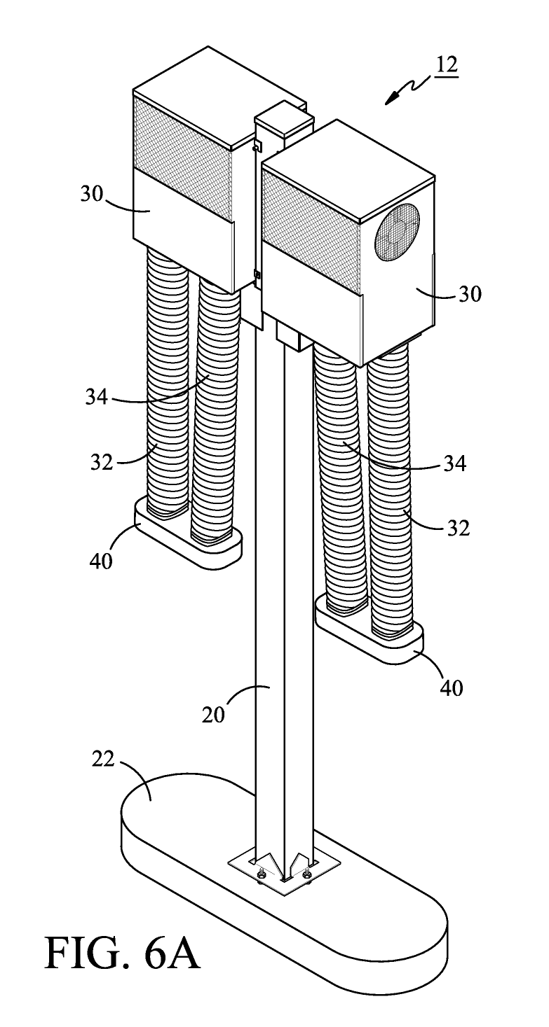

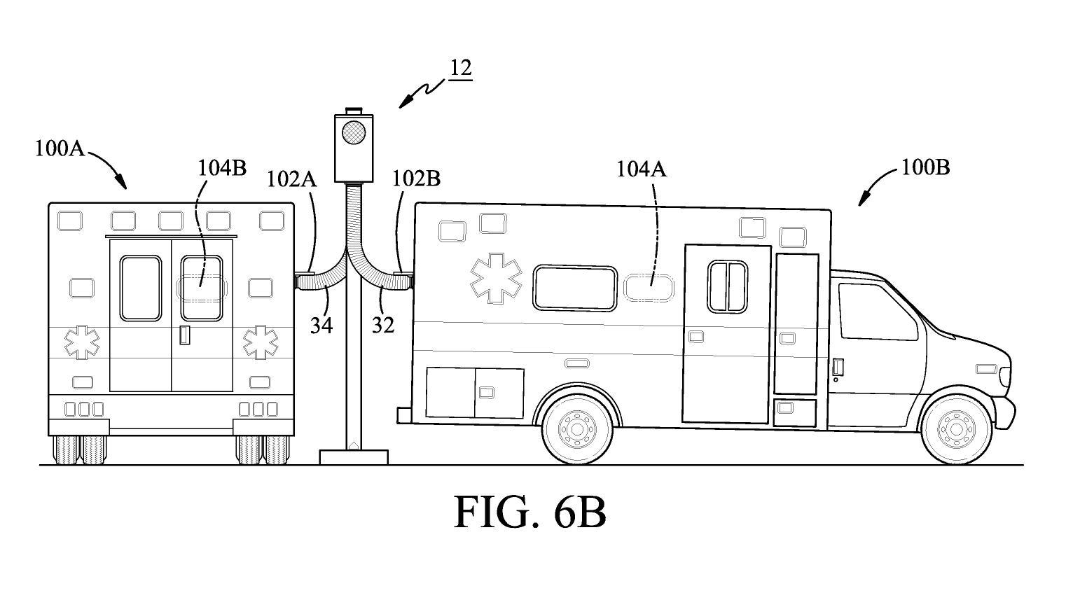

With reference to the drawings wherein like numerals represent like parts throughout the Figures, an HVAC system for vehicles is generally designated by the numeral 10 for a single station embodiment (FIG. 1) and by the numeral 12 for a dual station embodiment (FIG. 6A). The HVAC systems 10 and 12 provide HVAC service to a vehicle or vehicles while parked without the engines operating.

A tubular post 20 is mounted to a concrete support pad 22. The post 20 supports an HVAC module 30 in a cantilever-type mount near the top of the post. The HVAC module 30 provides the heating, ventilation and cooling functions. The HVAC module 30 is connected to power from the grid by a line through the post (not illustrated). In some embodiments, the HVAC module 30 also provides shore power to the vehicle. The HVAC module 30 optionally includes an interior ultraviolet light 36 to purify the flow path and reduce the spread of airborne diseases.

Two substantially identical flexible hoses 32 and 34 having an accordion-type configuration are suspended at the underside of the HVAC module. The ends of the hoses are coupled to a service module 40. The service module 40 is configured to be installed at a specially configured access port of a vehicle, as will be described below. The service module 40 has an air inlet opening 42 traversed by a screened inlet duct cover 44 communicating with flexible hose 32 and an air outlet opening 46 traversed by a screened outlet duct cover 48 communicating with flexible hose 34. Alternatively, only a single flexible hose and corresponding service panel opening may be employed.

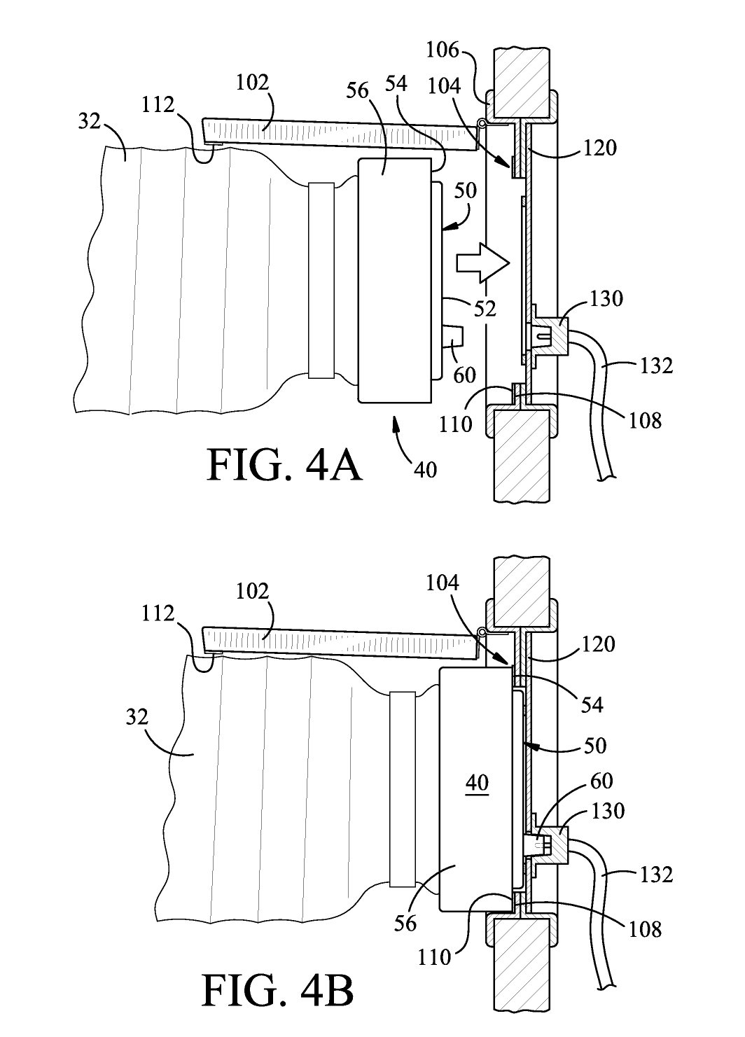

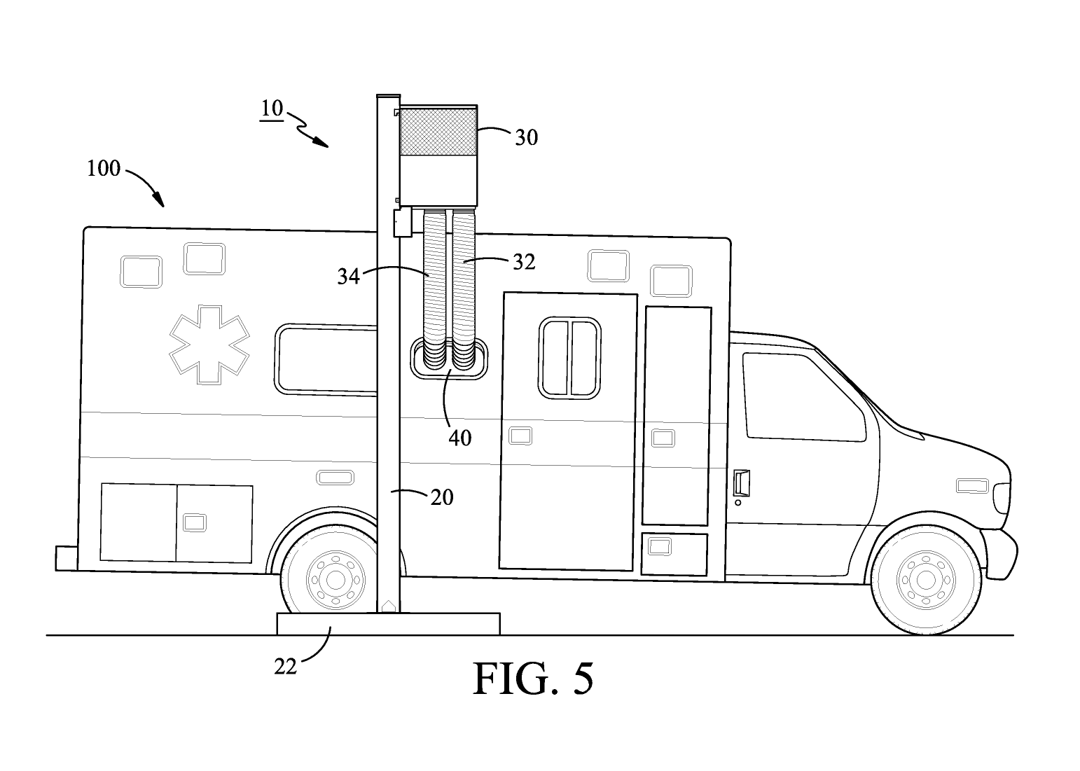

With reference to FIGS. 4A, 4B and 5, a preferred application is to provide HVAC service from HVAC module 30 via service module 40 to an ambulance. A representative ambulance is designated generally by the numeral 100. The ambulance is preferably modified to include an access door 102 which is preferably upwardly hinged. The door opens outwardly (upwardly) to provide an access opening or access port 104. The access door engages and mates with a frame assembly 106 with a circumferential flange 108 formed of metal and/or which mounts a magnetic gasket 110 disposed on the lower front portion of flange 108. The inside lower portion of the door preferably has a magnetic member 112 which magnetically bonds with magnetic gasket 110. An adapter plate assembly 120 (FIG. 3) is mounted at the interior side of the flange 108.

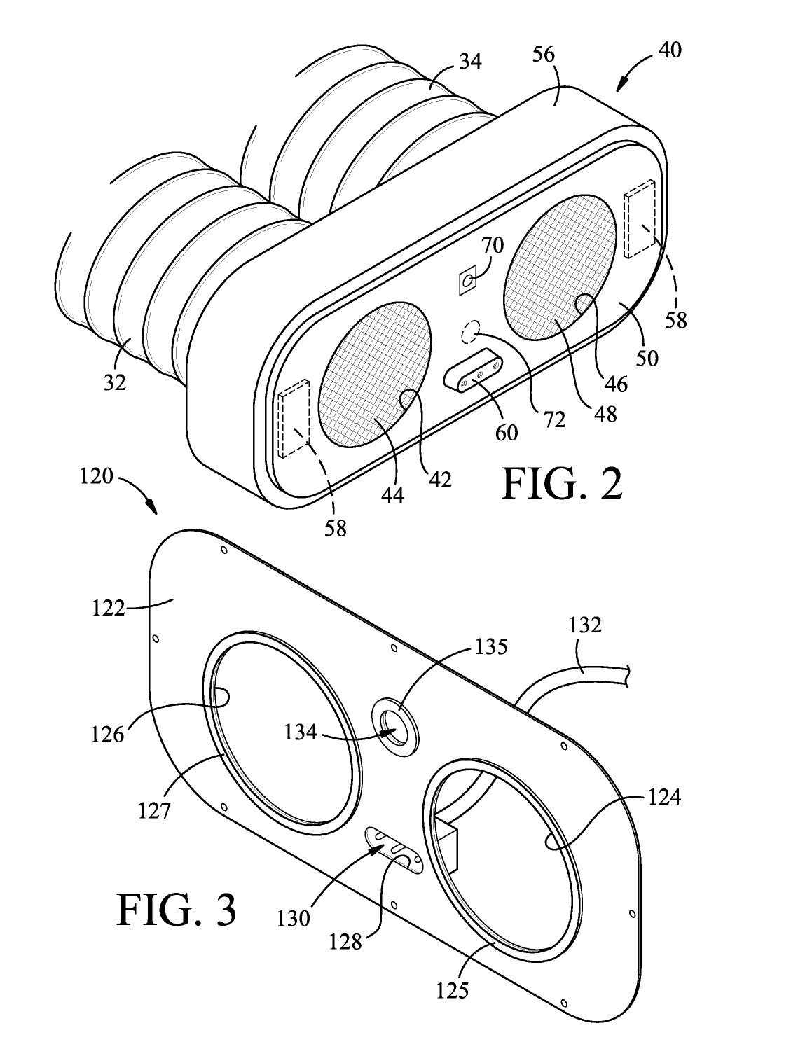

The hoses are extendable and positionable so that the service module 40 may be positioned and operational connected at the access port 104. With reference to FIG. 2, the service module 40 has a frontal panel 50 which is received in the access port 104 and engages or abuts the adapter assembly 120. The feed hose 32 and the return hose 34 communicate through the adapter assembly to the vehicle interior. The frontal panel 50 is configured to interact with the HVAC access window or access port 104 of the ambulance. The HVAC system 10 has applicability with any vehicle and need not be limited to an ambulance. In some embodiments, the access window may be merely a conventional vehicle window which may be retracted to receive the service module 40.

In some embodiments, the frontal panel 50 has a forward face 52 with a circumferential recessed rim 54. The rim 54 is dimensioned and recessed from the frontal panel 50 so that the frontal panel 50 may be received in the access opening or port 104 of the vehicle and engage the flange 108 (or gasket 110) of the frame assembly 106. A circumferential skirt 56 extends rearwardly from the rim 54. Magnets 58 are mounted at opposed locations of the service module and are structured and positioned to magnetically bond with the adapter assembly 120 for the access window or access port.

An electrical plug 60 protrudes from panel 50 for outwardly communicating forwardly to provide for shore power for the vehicle when it is in a parked, non-idling condition. The plug 60 connects with a power cord (not illustrated) which is preferably carried interiorly or exteriorly of one of the hoses. A temperature sensor 70 is mounted centrally over the frontal panel to monitor the interior temperature of the vehicle.

With reference to FIG. 3, an adapter plate assembly 120 is disposed at the access port and secured to the frame. The adapter plate assembly 120 comprises a steel adapter plate 122 which defines an inlet opening 124 and a return opening 126. The openings 124 and 126 are located and dimensioned upon engagement of the frontal plate against the adapter plate provide fluid communication from the inlet hose 32 and the outlet, or return hose 34, respectively. The adapter plate 122 preferably mounts 0-ring gaskets 125 and 127 which surround the respective openings 124 and 126 and engage against the frontal plate 50. The adapter plate 122 also defines a central opening 134 and an adjacent surrounding gasket 135 which align with and seal with the temperature sensor 70 of the service module. The adapter plate also has an oblong opening 128 which receives a power receptacle 130. The receptacle 130 receives the plug 60 and connects via a power cord 132 to provide shore power interiorly of the vehicle. Upon installing the service module in the access port, the plug 60 aligns and connects with the leads of the power receptacle 130 to implement an electrical connection between the service module and the power cord of the vehicle. In addition, it should be appreciated that the magnets 58 magnetically bond with the steel adapter plate 122 to provide a close fitting or snug engagement between the frontal plate 50 and the adapter plate assembly 120.

In an alternative service panel assembly or service module 140 illustrated in FIG. 13, a magnetic gasket 155 is disposed on a circumferential rim 154 of the service panel. The service module mounts a temperature sensor 170 as well as a tilt sensor 172. Other controls and indicators (not illustrated) may be carried by the service panel 140.

For service module 140, the tilt sensor 172 functions so that when the service module 140 is oriented in a general vertical position, the HVAC module can be turned on, and when the HVAC resumes the normal non-usage (substantially non-vertical) position (such as illustrated in FIG. 1), power to operate the HVAC module 30 terminates.

For the service module embodiment of FIG. 13, should the service module 40 be installed at the access port 104 and the vehicle leave without dismounting the service panel, the hoses 32 and 34 will automatically decouple from the service module 40 so that there will be no damage to the HVAC system other than the decoupling of the service module. The access door 104 will essentially drop to close and magnetically latch. The HVAC module will automatically shut off and any electrical leads to the service panel will readily decouple.

Each service module 40 or 140 is preferably dimensioned so that it is fully received in the opening or access port 104 so that the magnets 56 bond to the frame or circumferential magnetic gasket 50 engages the access door frame flange member 108 in a substantially airtight arrangement to provide communication of HVAC service to the interior of the ambulance while the ambulance is stationary. The service modules 40, 140 have a frontal portion with a geometrical shape which is generally complementary to the shape of the access port 104. It should be noted that the ambulance need not be running to operate its own HVAC system. Alternatively, the service modules 40 or 140 may be installed at a window of the cab (not illustrated).

With reference to FIG. 6A, a dual HVAC station system 12 can be potentially employed to simultaneously service two vehicles 100A and 100B. The vehicles may be parked in adjacent relationship on opposed sides of the post and a service module from each unit installed in place to the access openings or ports 104A and 104B of the vehicles. The vehicles may be oriented in a number of orientations with respect to an HVAC station, such as an opposite front-to-rear orientation, as best illustrated in FIG. 6B. The vehicles can have access doors 102A and 102B for ports 104A and/or 104B located, respectively, at a side location or a rear location.

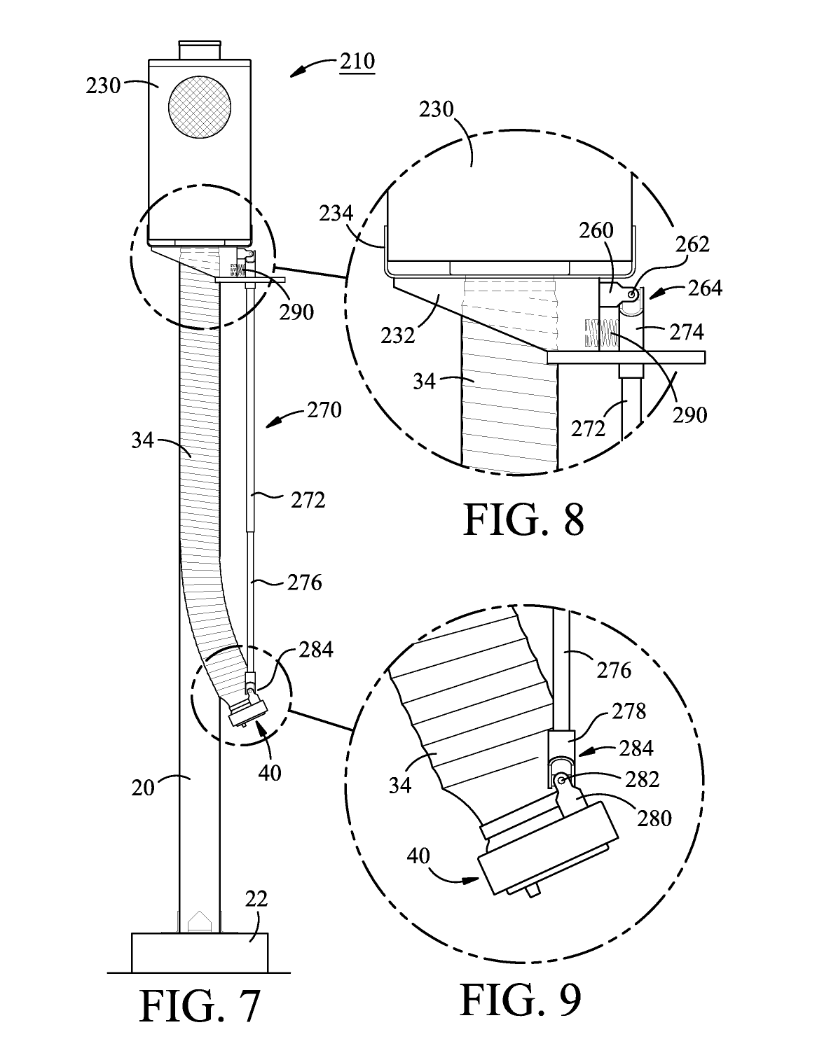

With reference to FIGS. 7-12, HVAC system 210 employs a quick disconnect feature which allows for the ambulance or other emergency vehicle to drive off while the service module 40 is positioned at the access port 104A or 104B of the vehicle without manually disconnecting the service module 40 and/or dismounting the service module from the vehicle and the service module 40 will decouple from the adapter assembly 120 and will remain tethered to the HVAC module 230 and available for subsequent usage. With reference to FIGS. 4A and 4B, the access door 102A or 102B will automatically pivot downward under the acceleration force of the vehicle and the magnets 110 and 112 will bond to latch the door 102A or 102B to close the access port 104A or 104B.

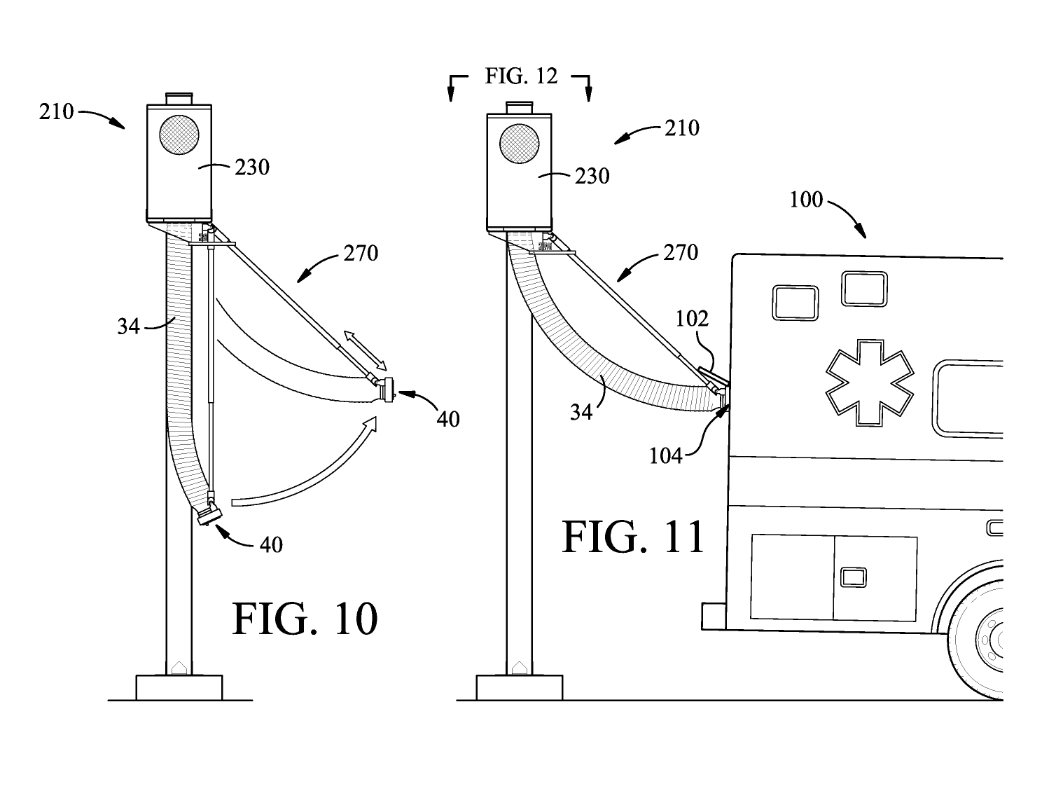

With reference to FIGS. 10 and 11, a telescoping tube assembly 270 functions as a swing-arm support which connects with the service module 240. The tube assembly is extendable and positionable so that the service module 240 may be positioned at the access port 104B which, in this embodiment, is at the rear of the ambulance.

The HVAC module 230 includes a center support member 232 extending from the underside of the HVAC module below the mounting bracket 234. A fixed stud or bracket 260 with a distal yoke 262 projects outwardly from the center support and connects via a universal joint 264 with a telescoping tube assembly 270. The telescoping tube assembly 270 comprises a tube 272 having a proximal connector sleeve 274. The connector sleeve 274 has an end which is pinned to the yoke to form the universal joint 238. A telescoping rod 276 reciprocates in the tube and at a remote end mounts a connector 278. The connector is pinned to a connecting stud 280 with a yoke 282 extending rearwardly from the service module 240. The connector 278 and yoke form a universal joint 284, as best illustrated in FIG. 9. The lower portion of the center support mounts a generally horizontally disposed quasi-V-shaped guide plate 250 which functions as a lateral pivot stop for the tube assembly 270.

A shock absorbing spring 290 is interposed between the support member 232 and the connector tube 272 to bias the tube assembly away from the HVAC post and to absorb an inward force applied against the telescoping tube assembly 270 (upon decoupling the service panel 240 from the access port) to prevent the tube assembly 270 from reactively moving rearwardly and engaging the center support, HVAC module, or the post.

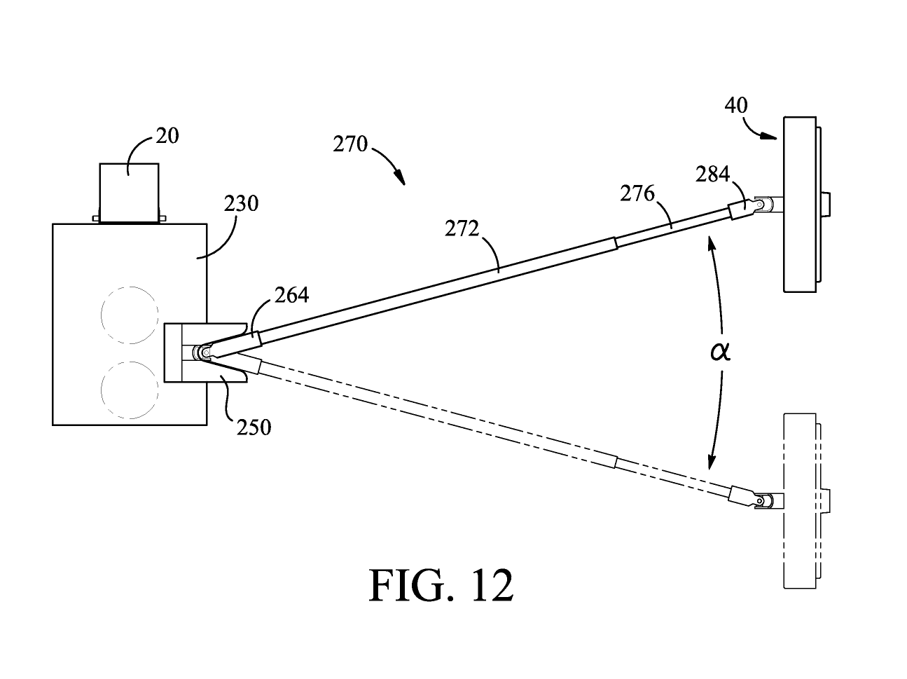

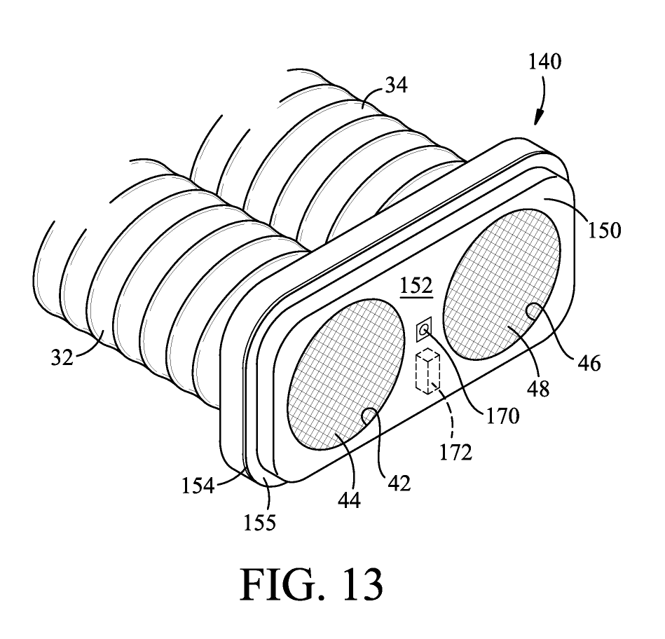

As best illustrated in FIG. 12, the guide plate 250 centrally receives a portion of the movable tube assembly and functions as a lateral stop so that the lateral angle a of the telescopic tube assembly is limited. Preferably, the limit is 30° for a side-to-side motion. It will be appreciated that the ambulance can drive off and the service module and the attached hoses are retained since the service module will easily disengage, i.e., the plug will disconnect the receptacle and the service module will be withdrawn from the opening as the ambulance drives away.

When the ambulance drives away, a motion or proximity sensor in the service module panel will immediately turn off the HVAC unit, and the current will also be terminated through the cord to the plug.

While preferred embodiments have been set forth for purposes of illustration, the foregoing descriptions should not be deemed a limitation of the invention herein. Accordingly, various modifications, adaptations and alternatives may occur to one skilled in the art without departing from the spirit and the scope of the present invention.

1. An HVAC system for a vehicle comprising:
a post disposed in an upright relationship;
an HVAC module mounted to said post and having a bottom panel;
at least one flexible hose suspended from the bottom panel of said HVAC module;
a service module receiving an end portion of each said flexible hose, said service module defining a circumferential rim; and
a magnet carried by said service module.

2. The HVAC system of claim 1 wherein said service module further has a tilt sensor or a proximity sensor.

3. The HVAC system of claim 1 wherein said service module has a frontal service panel and a temperature sensor is mounted at said service panel.

4. The HVAC system of claim 1 wherein each said flexible hose is further decouplable from said service module.

5. The HVAC system of claim 1 further comprising a second HVAC module mounted to said post opposite said first HVAC module and further comprising a second set of at least one flexible hose suspended from a bottom panel of said second HVAC module, and a second service module receiving an end of each said flexible hose of said second set.

6. In combination:
a vehicle having a service door which opens to define an access port having an adapter, said adapter defining an inlet and an outlet; and
an HVAC system comprising:
an upright post;
an HVAC module mounted to said post at an elevated position and having a panel;
a pair of flexible hoses extending from said panel and having end portions; and
a service module mounted to said end portions and suspendable from said HVAC module,
wherein said service module is positioned at said access port with said hoses fluidly communicating with said inlet and said outlet and said service module is magnetically attracted toward said adapter.

7. The combination of claim 6 wherein said service module carries a pair of magnets and said adapter comprises a metal plate.

8. The combination of claim 6 wherein said service module has a temperature sensor.

9. The combination of claim 6 wherein said service door is pivotally mounted to the vehicle at an upward location of said service door, and opens outwardly from the vehicle.

10. An HVAC station comprising:
an HVAC module;
a pair of flexible hoses connecting said HVAC module;
a service panel assembly receiving ends of said hoses; and
a tether assembly connecting said HVAC module and said service panel assembly, wherein said panel assembly may be installed in an access port of a stationary vehicle in a substantially vertical orientation and upon driving said vehicle away from said HVAC station, said panel assembly is dismounted from said access port and is tethered to said HVAC module by said tether assembly.

11. The HVAC station of claim 10 wherein said tether assembly comprises a telescopic assembly comprising a tube and a telescoping rod wherein said tube has a first connector and said rod has a second connector which connects with said service panel assembly.

12. The HVAC station of claim 11 wherein said HVAC module has a forwardly projecting bracket and said first connector connects said bracket in a universal connection.

13. The HVAC station of claim 11 wherein said second connector connects said service panel assembly in a universal connection.

14. The HVAC station of claim 11 further comprising a guide projecting forwardly from said HVAC module and comprising a pair of spaced edges which define a stop for limiting lateral displacement of said telescopic assembly.

15. The HVAC station of claim 10 wherein said service panel assembly further comprises an electrical connector and a cord extends from said HVAC module to said electrical connector.

16. The HVAC station of claim 10 wherein said service panel assembly has a temperature sensor and carries a pair of magnets.

17. The HVAC station of claim 11 further comprising an absorber spring assembly interposed between said telescopic assembly and said HVAC module to provide a shock absorber to limit displacement of said telescopic tube assembly.

18. The HVAC station of claim 10 wherein said service panel assembly comprises a frontal panel and a recessed circumferential rim.

19. The HVAC station of claim 10 wherein said HVAC module comprises bottom panel and said pair of flexible hoses extend from said bottom panel and said hoses are substantially identical with a substantially accordion fold-type construction.

20. The HVAC station of claim 10 and further comprising an ambulance comprising a cab and a carrier compartment having an access port at a side or rear location of said carrier compartment, said service panel assembly is positioned at said access port, and said service panel assembly and said access port have generally complementary shaped portions.
